(19) United States
(12) Patent Application Publication
(10) Pub. No.: US 2006/0209106 A1
(43) Pub. Date: Sep. 21, 2006

(54) Document management apparatus, document management method, program for implementing the method, and document management system

(75) Inventor: Hiroshi Kikuchi, Musashino-shi (JP)

Correspondence Address: ROSSI, KIMMS & McDOWELL LLP., P.O. BOX 826, ASHBURN, VA, 20146-0826, US

(73) Assignee: Canon Kabushiki Kaisha, Ohta-ku (JP)

(21) Appl. No.: 11/360,372

(22) Filed: Feb. 23, 2006

(30) Foreign Application Priority Data
Feb. 23, 2005 (JP) 2005-047506
Jan. 16, 2006 (JP) 2006-007975

(51) Int. Cl. B41J 29/38

(52) U.S. Cl. 347/9

(57) ABSTRACT

A document management apparatus which is capable of replacing a plurality of kinds of marks with a mark having a common meaning without editing the marks to output consistent printing results in an efficient manner. A mark information management table in which a plurality of kinds of marks are classified into groups, and one of the marks in each of the groups is set as a head mark is held, and marks added to-data are replaced with head marks by referring to the mark information management table when printing of the data is instructed.

### BACKGROUND OF THE INVENTION

1. Field of the Invention

The present invention relates to a document management apparatus, a document management method, a program for implementing the method, and a document management system. In particular, the present invention relates to a document management apparatus and a document management method which are capable of printing mark information such as watermarks and annotations in a document file or an image file when performing a print job for such a file, as well as a program for implementing the method and a document management system.

2. Description of the Related Art

Conventionally, there has been a document management system which has a function of adding predetermined drawing objects to data files being managed by the system. The drawing objects to be added are marks and stamps such as so-called watermarks, annotations, form overlays, and variable data. The document management system also has a function of binding a plurality of files created by a plurality of software applications (hereinafter simply referred to as “the applications”), managing them as a binder, and adding marks or the like to the binder. As is the case with the document management system, some of the applications have a function of adding marks and others to files concerned.

Thus, there is the possibility that a plurality of kinds of marks are added to one binder. For example, in the case where files for internal use only are bound to create a binder for internal use only that is printed by the document management system, some original files have the mark “For internal use only” added thereto while others do not have. When a print job for the binder to which the mark “For internal use only” is added is executed in consideration of the files to which the mark is not added, a plurality of formats of the mark “For internal use only” are mixed in the printing result, giving a sense of lack of consistency to the printing result.

In the above example, all the marks “For internal use only” are consistent with one another. If, unlike this, different marks such as “Secret” and “Confidential” are added to files to be bound, a more inconsistent printing result would be presented. To address this problem, there has been proposed a technique capable of editing additional drawing objects such as stamps and marks so that the user can obtain a consistent printing result (see Japanese Laid-Open Patent Publication (Kokai) No. 2004-005576).

Some printer drivers have a function of adding marks to a print job, and there may be cases where such marking is performed by a device such as a printer. In this regard, there has been proposed a technique for associating annotations as information to be added in printing with files, so that the most suitable printer capable of printing the annotation information can be searched for to perform printing of such information (see Japanese Laid-Open Patent Publication (Kokai) No. 2004-118509).

According to the conventional technique disclosed in Japanese Laid-Open Patent Publication (Kokai) No. 2004-005576 mentioned above, marks and others can be edited, however it is necessary to individually manually edit a plurality of different kinds of marks such as “For internal use only” and “Confidential” in order to obtain an output result to which consistent marks are added. Thus, there is a demand to increase the efficiency of operation.

According to the conventional technique disclosed in Japanese Laid-Open Patent Publication (Kokai) No. 2004-118509 mentioned above, information on annotations to be added to data files are collectively managed and presented to the user so that the user can search for the most suitable printer capable of printing the annotation information. However, this technique is not intended to change locations (such as applications, drivers, and devices) for actually adding marks to data files such as document files and image files, and hence there is the problem that mark images are not satisfactory or performance deteriorates depending on data formats and file storage locations. For this reason, the user has to determine the timing of the addition of marks in consideration of the type of document management system and the type of printer.

Although with the conventional document management system, it is possible to handle data in which various formats are mixed in a plurality of pages and to instruct addition of a stamp on a page-by-page basis or to the entire file, it is impossible to specify which service is to be used for adding stamps. Thus, for example, even when different formats are mixed in a device job document, the document management system may add stamps to the device job document, resulting in poor performance and image quality.

### SUMMARY OF THE INVENTION

It is a first object of the present invention to provide a document management apparatus and a document management method which are capable of replacing a plurality of kinds of marks with a mark having a common meaning without editing respective ones of the marks, to thereby obtain a print output giving a feeling of consistency in an efficient manner.

It is a second object of the present invention to determine a marking service suitable for handling even such data in which various formats are mixed.

To attain the above objects, in a first aspect of the present invention, there is provided a document management apparatus that adds at least one mark to data and causes a printing apparatus to print the data, comprising a mark information storing device that stores a mark information management table which includes a plurality of kinds of marks that are classified into groups, and head marks as each of which one of marks belonging to a corresponding one of the groups is set, and a mark replacing device that replaces at least one mark added to the data with at least one of the head marks by referring to the mark information management table when an instruction for printing the data is given to the printing apparatus.

With this arrangement, the mark information management table in which a plurality of kinds of marks are classified into groups, and one of the marks in each group is set as a head mark is held, and a plurality of kinds of marks added to data are replaced with the head mark by referring to the mark information management table when printing of the data is instructed. It is therefore possible to replace a plurality of kinds of marks with a mark having a common meaning without editing the marks to obtain consistent printing results in an efficient manner.

To attain the above objects, in a second aspect of the present invention, there is provided a document management method for a document management apparatus that adds at least one mark to data and causes a printing apparatus to print the data, comprising a mark information storing step of storing a mark information management table which includes a plurality of kinds of marks that are classified into groups, and head marks as each of which one of marks belonging to a corresponding one of the groups is set, and a mark replacing step of replacing at least one mark added to the data with at least one of the head marks by referring to the mark information management table when an instruction for printing the data is given to the printing apparatus.

To attain the above objects, in a third aspect of the present invention, there is provided a computer-readable program for causing a computer to implement a document management method for a document management apparatus that adds at least one mark to data and causes a printing apparatus to print the data, comprising a mark information storing module for storing a mark information management table which includes a plurality of kinds of marks that are classified into groups, and head marks as each of which one of marks belonging to a corresponding one of the groups is set, and a mark replacing module for replacing at least one mark added to the data with at least one of the head marks by referring to the mark information management table when an instruction for printing the data is given to the printing apparatus.

To attain the above objects, in a fourth aspect of the present invention, there is provided a document management system that sends data with at least one predetermined mark added thereto from an information processing apparatus to a printing apparatus, the information processing apparatus comprising a mark information storing device that stores a mark information management table which includes a plurality of kinds of marks that are classified into groups, and head marks as each of which one of marks belonging to a corresponding one of the groups is set, a service table storing device that stores a marking service table in which data formats, storage locations of marks that can be added to data having the data formats, and suitable programs for adding these marks are set, a mark replacing device that replaces at least one mark added to the data with at least one of the head marks by referring to the mark information management table when an instruction for printing the data is given to the printing apparatus, and a determining device that determines a suitable program for adding the at least one of the head marks by referring to the marking service table when the instruction for printing the data is given to the printing apparatus.

To attain the above objects, in a fifth aspect of the present invention, there is provided an information processing apparatus comprising an execution device that executes a plurality of services for outputting data, a determining device that determines a service for adding marks from among the plurality of services, and an output control device that controls output processing of the service determined by the determining device such that the data with the marks added thereto is output.

With this arrangement, a service for marking is determined from among a plurality of services for outputting data, and output processing of the determined service is controlled so as to output data with marks added thereto. Thus, even when data in which various formats are mixed is handled, it is possible to determine a suitable marking service and realize high printing performance and high printing quality.

To attain the above objects, in a sixth aspect of the present invention, there is provided an information processing method comprising an execution step of executing a plurality of services for outputting data, a determining step of determining a service for adding marks from among the plurality of services, and an output control step of controlling output processing of the service determined in the determining step such that the data with the marks added thereto is output.

To attain the above objects, in a seventh aspect of the present invention, there is provided a program readable by a computer, comprising an execution module for executing a plurality of services for outputting data, a determining module for determining a service for adding marks from among the plurality of services, and an output control module for controlling output processing of the service determined by the determining module such that the data with the marks added thereto is output.

The above and other objects, features, and advantages of the invention will become more apparent from the following detailed description taken in conjunction with the accompanying drawings.

### BRIEF DESCRIPTION OF THE DRAWINGS

FIG. 1 is a block diagram showing the hardware configuration of a printing system to which a document management method according to an embodiment of the present invention is applied;

FIG. 2 is a block diagram showing the functional configuration of the printing system in FIG. 1;

FIG. 3 is a view showing in detail a mark information management table managed by a document management system appearing in FIG. 2;

FIG. 4 is a view showing in detail a marking service table managed by the document management system;

FIG. 5 is a view showing an example of a display screen displayed by the document management system;

FIG. 6 is a view showing an example of mark control information managed by the document management system;

FIG. 7 is a flow chart showing a mark managing process carried out by the document management system during printing of a predetermined file;

FIG. 8 is a flow chart showing in detail a mark ID managing process in a step S133 in FIG. 7;

FIG. 9 is a flow chart showing in detail a replacement-with-head-mark process in a step S134 in FIG. 7;

FIG. 10 is a flow chart showing in detail a marking service determining process in a step S138 in FIG. 7;

FIG. 11 is a view showing an example of mark control information read by the document management system before the process in FIG. 7 is started;

FIG. 12 is a view showing mark control information immediately before the execution of a step S136 in FIG. 7;

FIG. 13 is a view showing mark control information immediately after the execution of the step S136 in FIG. 7;

FIG. 14 is a view showing mark control information immediately before the execution of a step S137 in FIG. 7;

FIG. 15 is a view showing mark control information after the completion of the process in FIG. 7; and

FIG. 16 is a view showing an example of print job data to be printed, which includes mark data.

### DETAILED DESCRIPTION OF THE PREFERRED EMBODIMENTS

The present invention will now be described in detail with reference to the drawings showing a preferred embodiment thereof.

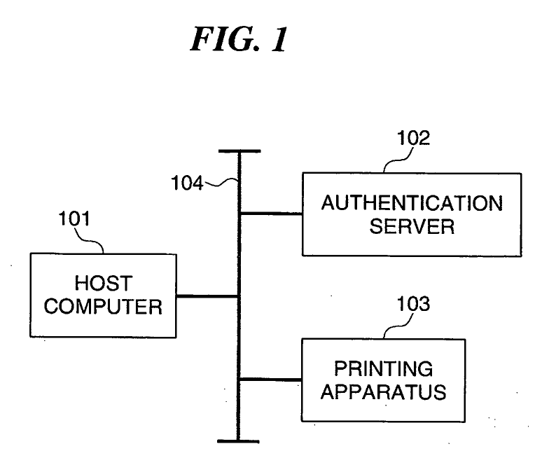

FIG. 1 is a block diagram showing the hardware configuration of a printing system to which a document management system according to an embodiment of the present invention is applied.

As shown in FIG. 1, the printing system (document management system) according to the embodiment is configured such that a host computer 1000 which is an information processing apparatus and a printer 3000 which is a printing apparatus are connected to each other via a two-way interface 31. Although in FIG. 1, one host computer 1000 and one printer 3000 are connected to each other, this is not limitative, but a plurality of printers, servers, multi-function apparatuses, and so forth may be connected to one. another. Also, the interface 31 may alternatively be a network such as a LAN (local area network) or the Internet.

In the host computer 1000 in FIG. 1, a keyboard 9 which is an input device, a CRT (Cathode-Ray Tube) 10 which is a display device, and a hard disk 11 are connected as external devices to a computer main unit 2000, to thereby realize a computer system.

The computer main unit 2000 is comprised mainly of a CPU (Central Processing Unit) 1, a RAM (Random-Access Memory) 2, a ROM (Read-Only Memory) 3, a keyboard controller (KBC) 5, a CRT controller (CRTC) 6, a hard disk controller (HDC) 7, a printer controller (PRTC) 8, and a system bus 4.

The CPU 1 executes processing, described later, by loading control programs and application software (hereinafter simply referred to as “the applications”) stored in the ROM 3 and the hard disk 11 into the RAM 2. The KBC 5 controls input from the keyboard 9. The CRTC 6 controls the display on the CRT 10. The HDC 7 controls input and output to and from the hard disk 11.

The PRTC 8 is connected with the printer 3000 via the interface 31 and controls communication with a printer controller 4000 of the printer 3000. The CPU 1, RAM 2, ROM 3, KBC 5, CRTC 6, HDC 7, and PRTC 8 are connected to one another via the system bus 4 and collectively controlled by the CPU 1.

To print a document file or an image file created using an application, the user sends a print job of the document file or image file from the host computer 1000 to the printer 3000 and causes the printer 3000 to perform a printing process.

In the printer 3000, a printing mechanism unit 28 (printer engine), a hard disk 29, and an operating panel 30 are connected to the printer controller 4000.

The printer controller 4000 is comprised mainly of a CPU 21, a RAM 22, a ROM 23, an input/output section 25, a printing section 26, a hard disk controller (HDC) 27, and a bus 24.

The CPU 21 collectively controls access to these devices connected to the bus 24 in accordance with control programs and others stored in the ROM 23 which is a program ROM. The CPU 21 also outputs image signals as print data to the printing mechanism unit 28 via the printing section 26. The CPU 21 is capable of communicating with the host computer 1000 via the input/output section 25 and sending information and others in the printer 3000 to the host computer 1000.

The RAM 22 functions as a main memory, a work area, and so forth for operation of the CPU 21. The memory capacity of the RAM 22 can be expanded using an optional RAM connected to an expansion port, not shown. The RAM 22 is also used as a drawing memory, a video signal information storage area, and so forth for storing print data comprised of a printing command group and image bitmap data.

The hard disk 29 is controlled by the HDC 27 and used as a BOX for storing information such as stamps and marks, described later, and print jobs. Examples of the information such as stamps include watermarks, annotations, form overlays, and variable data.

The operating panel 30, which is a user interface for the user to operate the printer 3000, is comprised of various switches, LED (Light Emitting Diode) display device, touch-sensitive LCD panel, and so forth.

The printer 3000 may be implemented by either a single-function printer or a multi-function printer having a plurality of functions such as a scanner function, a copying function, and a facsimile function insofar as the functions of the present invention can be realized. Although in the present embodiment, it is assumed that the printing mechanism unit 28 is based upon laser-beam printing, this is not limitative, but the printing mechanism unit 28 may be based upon inkjet printing, thermal printing, or other printing technique.

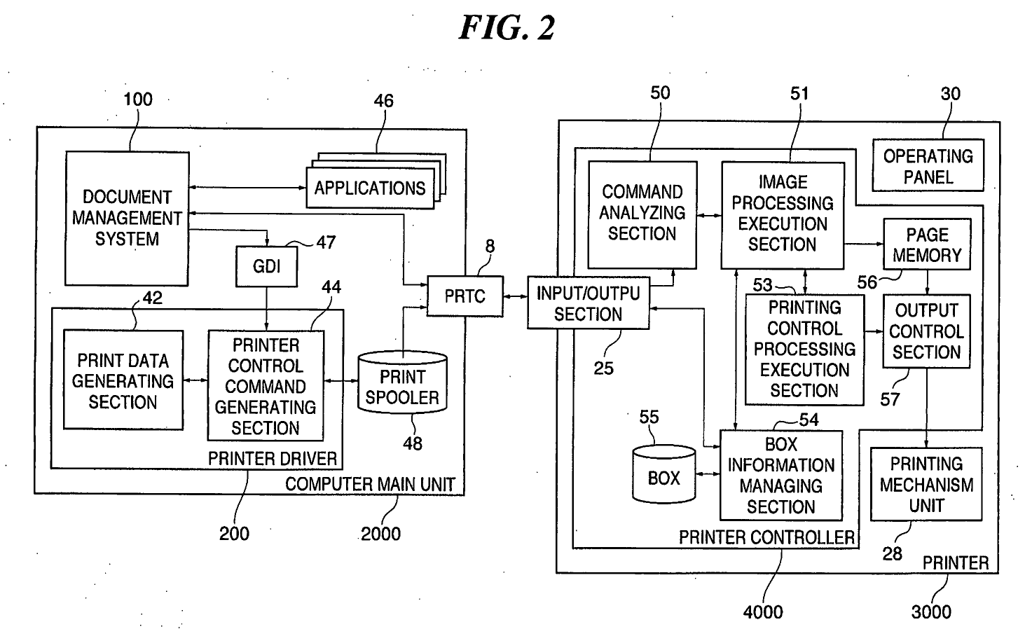

FIG. 2 is a block diagram showing the functional configuration of the printing system in FIG. 1.

The computer main unit 2000 appearing in FIG. 1 functions as a server or a client in the printing system in FIG. 1 and outputs a print job comprised of printing control commands and a bit-mapped image as print data to the printer 3000.

In terms of functions, the computer main unit 2000 is divided broadly into a document management system 100, a printer driver 200, applications 46 for creating document files and image files that are managed by the document management system 100, a graphic device interface (GDI) 47, and a print spooler 48 for temporarily storing data generated by the printer driver 200. The printer driver 200 is comprised of a print data generating section 42 and a printer control command generating section 44.

In the computer main unit 2000, hardware such as the above-mentioned CPU 1, RAM 2, ROM 3, and hard disk 11 is controlled by software called a basic OS (Operating System) such as the Windows (registered trademark), UNIX (registered trademark), or Mac (registered trademark) OS, and application software (applications) runs on the basic OS. There may be cases where the above-mentioned names and functional schemes vary to some extent depending on basic operating systems, but any names and functional schemes may be adopted insofar as modules can realize technical functions of the present embodiment.

Modules represented by the names “GDI” and “printer driver” specific to the Windows (registered trademark) OS may be realized by functionally equivalent modules in other operating systems such as for example a so-called graphic kernel. Also, the print spooler 48 may be realized by embedding processing into a module called a print cue.

The printer driver 200 is placed as one of such applications. Examples of the applications 46 include a word processing application, a spreadsheet application, and so forth, which run on the basic OS. It is possible to start a plurality of applications 46 in arbitrary timing.

Next, a description will be given of a printing process carried out in the case where arbitrary image editing software is used as the application 46.

To edit an image using the application 46 and print the image, the user selects a print menu displayed on the CRT 10 using the keyboard 9 or a pointing device, not shown, such as a mouse so that printing can be performed.

The application 46 calls the GDI 47 as one of the functions of the basic OS. The GDI 47 is a group of fundamental functions that control display devices such as the CRT 10 that provides a display screen and printing devices such as the printer 3000 that performs a printout. With the computer main unit 2000 using the fundamental functions, it is possible to run the application 46 without paying particular attention to dependency on the type of computer (hardware).

The GDI 47 captures information such as the drawing capability and the printing resolution of the printer 3000 from the printer driver 200 that manages printer-type-dependent information and performs processing using API (Application Program Interface) functions called by the application 46. In accordance with the contents of the processing, the printer driver 200 calls functions to be provided for the GDI 147. The functions provide predetermined interfaces (Device Driver Interfaces: DDIs). The printer driver 200 is usually prepared with particular emphasis on data conversion for outputting data from the DDIs to the actual printer.

The printer driver 200 causes the print data generating section 42 and the printer control command generating section 44 to perform predetermined processing in accordance with the DDI information received from the GDI 47 and printing environments set by the user on a graphical user interface (GUI) displayed by the printer driver 200, to thereby generate print data and control commands. The printer driver 200 then sends the generated print data and control commands to the print spooler 48. The print data and the control commands are sent from the print spooler 48 to the printer 3000 via the PRTC 8.

As described above, when the application 46 is set as a program for adding marks to data such as document files and image files, the application 46 processes data using the API functions so as to output marks, and when the printer driver 200 is set as such a program, the printer driver 200 processes data using the API functions so as to output marks.

A description will now be given of the software configuration of the printer 3000.

The printer 3000 is divided broadly into the printer controller 4000, the operating panel 30, and the printing mechanism unit 28 in terms of functions.

The printer controller 4000 is comprised of the input/output section 25 serving as a connecting section with the computer main unit 2000, a command analyzing section 50 that analyzes print data control commands received from the computer main unit 2000, an image processing execution section 51, a printing control processing execution section 53, a page memory 56, an output control section 57, a BOX information managing section 54, and a BOX 55.

A description will now be given of the operation of the above-mentioned parts of the printer controller 4000.

The print data and the control commands received from the computer main unit 2000 via the input/output section 25 are read out and processed as necessary by the command analyzing section 50 and the image processing execution section 51.

The BOX 55 is a storage area provided in the hard disk 29. The BOX 55 stores mark information for putting marks to data files by the printer 3000. The mark information stored in the BOX 55 can be referred to from externally of the printer controller 4000 via the image processing execution section 51 and the input/output section 25. The mark information can also be referred to by the user by designating the mark information via the operating panel 30.

In using mark information or the like stored in the BOX 55, the image processing execution section 51 exchanges data with the BOX information managing section 54 to acquire the mark information from the BOX 55. The image processing execution section 51 expands compressed image data by successively loading objects such as characters and images into the page memory 56, while performing image processing on these objects.

The page memory 56 is managed by banding control which involves competition between the expansion of image data and the output of video signals to the printing mechanism unit 28. If the page memory 56 has enough memory capacity, an area where one-page image data can be expanded is ensured.

The output control section 57 converts the image data expanded in the page memory 56 into video signals and transfers the video signals to the printing mechanism unit 28. The printing control processing execution section 53 controls the transfer process of the image data in timing with the image processing execution section 51. The printing mechanism unit 28 forms images on recording sheets based upon the video signals received from the output control section 57.

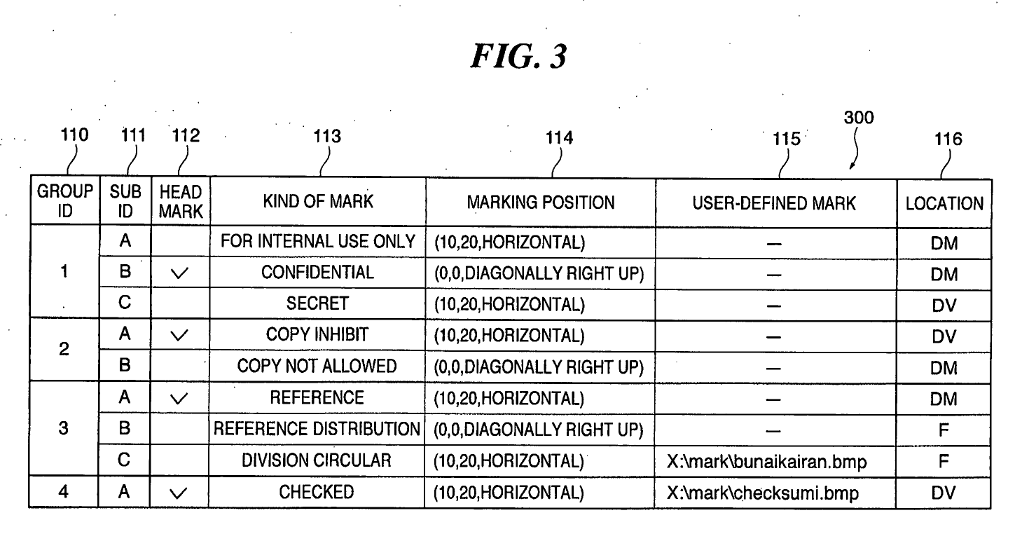

Referring next to FIG. 3, a description will be given of a mark information management table managed by the document management system 100 appearing in FIG. 2.

FIG. 3 is a view showing in detail the mark information management table managed by the document management system 100 appearing in FIG. 2.

The mark information management table 300 in FIG. 3 is a management table for unifying a plurality of kinds of marks added to a binder, which is formed by binding a plurality of files created by a plurality of applications into one file, to a mark (head mark) having the same meaning as these kinds of marks. The mark information management table 300 is stored in the hard disk 11 by the document management system 100.

In the mark information management table 300, group IDs 100, sub IDs 111, head mark indication 112, kinds of marks 113, marking positions 114, user-defined mark storage locations 115, and mark storage locations 116 are managed.

The kinds of marks that are currently managed by the document management system 100 are registered as the kinds of marks 113. Examples of the kinds of marks include marks “Confidential” and “Copy not allowed” as shown in FIG. 3. The registered marks may be either those added by an arbitrary application or those added using a marking function of the document management system 100.

The marks added by an arbitrary application can be recognized and managed by the document management system 100 insofar as they are printed out as general-purpose information such as XML (Extensible Markup Language). Also, if the marks are stored in the form of files created by applications and stored in storage formats that have been open to public, the document management system 100 can recognize the marks based upon file information.

On the other hand, marks added using the function of the document management system 100 are those added to arbitrary pages of files created by arbitrary applications using the marking function of the document management system 100. By the use of this marking function, it is possible to put marks with the same format to a binder obtained by, for example, binding a plurality of files created by a plurality of applications into one file.

All the marks registered in the mark information management table 300 are classified into groups. For example, marks “Confidential” and “Secret” are managed in the same group. The marks in the same group are ones used for similar purposes from standpoint of the user and designated by the user as having similar purposes. The user can classify marks into groups in an arbitrary manner and can also newly add and change marks.

Group IDs are assigned to respective groups and registered as the group IDs 110. Sub IDs, which are assigned to respective marks belonging to the same group so that they can be discriminated from one another, are registered as the sub IDs 111. Thus, when the user or the document management system 100 identifies a group ID and a sub ID, the corresponding mark can be identified.

With the head mark indication 112, one of a plurality of marks registered in the same group is set as a head mark. The head mark means the first mark on the user's wish list of marks to be used among a plurality of marks included in the concerned group. In the document management system 100, various marks and stamps added to data such as document files and image files are recognized, and the marks having a common meaning are grouped. Among a plurality of marks in the same group, the first mark on the user's wish list of marks to be used is set as a head mark.

As the marking positions 114, marking positions on data file are registered. The head marks are put at positions (coordinates) designated as the marking positions 114. It should be noted that the coordinates each represent the relative coordinate of the central position of a corresponding mark with respect to the central position of a printing area on data file. As the marking positions 114, the directions in which marks are printed (horizontal, diagonally right up, and so forth) are also registered.

In the case of the user-defined marks 115 that are managed in other files (for example, bit-mapped files) in the document management system 100, character strings indicating paths to these files are registered.

As the mark storage locations 116, the storage locations of the concerned marks are registered. In FIG. 3, “DM” means that the concerned mark exists and is managed in the document management system 100, “F” means that the concerned mark exists in a data file that is input to be printed, and “DV” means that the concerned mark exists and is managed in the BOX information managing section 54.

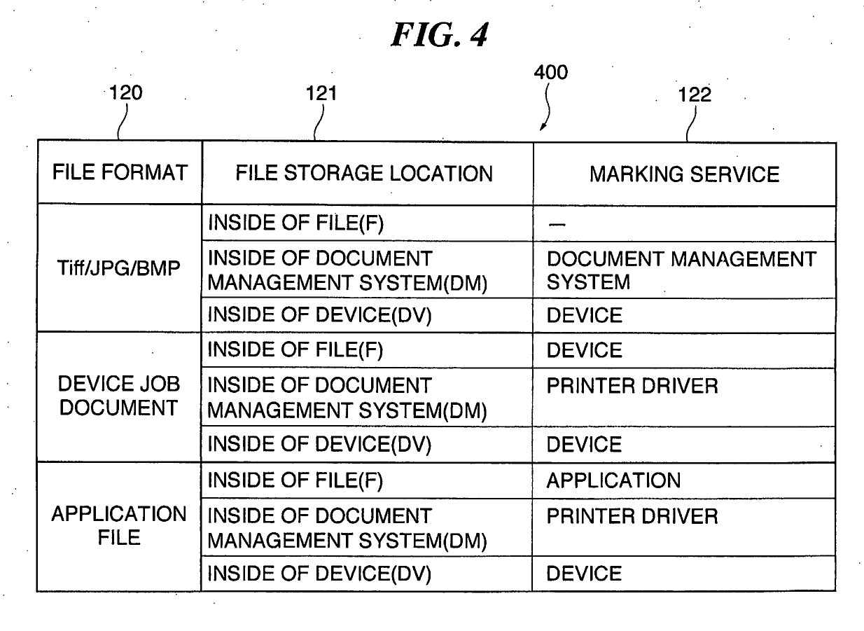

Referring next to FIG. 4, a description will be given of a marking service table managed by the document management system 100.

FIG. 4 is a view showing in detail the marking service table managed by the document management system 100.

In FIG. 4, the marking service table 400 is a management table for managing the file formats of data to which marks are to be added, the storage locations of marks that can be added to the data, and the most suitable services (such as programs and devices) for putting head marks.

In the marking service table 400, file formats 120, mark storage locations 121, and marking services 122 are managed.

As the file formats 120, “file format” information (for example, TIFF/JPG/BMP, device job document, and application file) on data to which marks are to be added are registered. As the mark storage locations 121, the locations where marks are stored (for example, the inside of the file (F), the inside of the document management system (DM), and the inside of the device (DV)) are registered. As the marking services 122, pieces of information on programs suitable for marking (for example, programs, printer drivers, and devices) are registered. It should be noted that the “device job document” as the file format 120 represents document files stored in the hard disk 29 of the printer 3000, that is, in the present embodiment, files that can be bound etc. on the document management system 100.

The marking service tables 400 are individually created in accordance with computer capabilities and printer capabilities. As is the case with the mark information management table 300 described above, the user can edit the marking service table 400 so as to cope with even the situation where part of printer functions is disabled.

By referring to the marking service table 400, the document management system 100 can find the most suitable service for actually marking, such as a program, printer driver, device, or the like based upon the file formats of data to which marks are to be added and the storage locations of the marks.

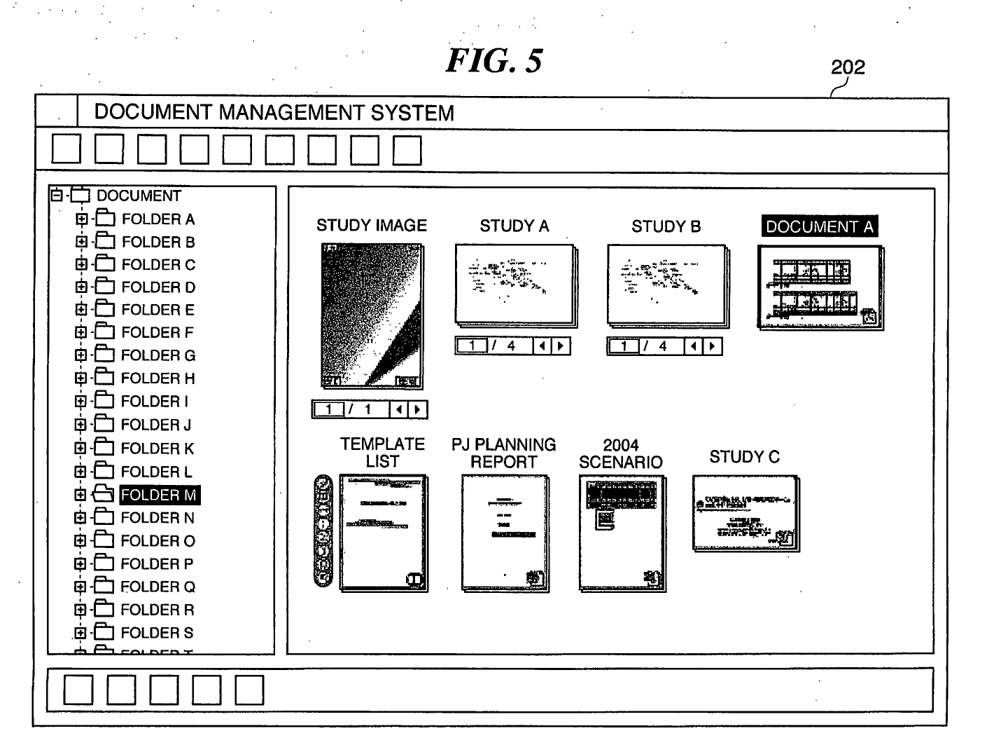

FIG. 5 is a view showing an example of a display screen displayed by the document management system 100. 20 The display screen 202 in FIG. 5 is displayed on the CRT 10 by the graphical user interface (GUI) of the document management system 100. The folder structure of document files being managed is displayed in the form of a tree in the left portion of the screen 202, and folders, binders, and so forth stored in an active folder are previewed in the right portion of the screen 202.

In the right portion of the screen 202, files stored in the BOX 55 of the printer 3000 as well as files being managed on the computer including files created by applications are displayed. It is therefore possible to create a binder by binding the files stored in the BOX 55 and the files stored in the host computer 1000.

Such files and binders are each comprised of a plurality of pages. By designating pages in a menu or designating pages with the mouse using a function of the document management system 100, arbitrary marks can be put on the designated pages. Also, marks can be edited using a function of the document management system 100.

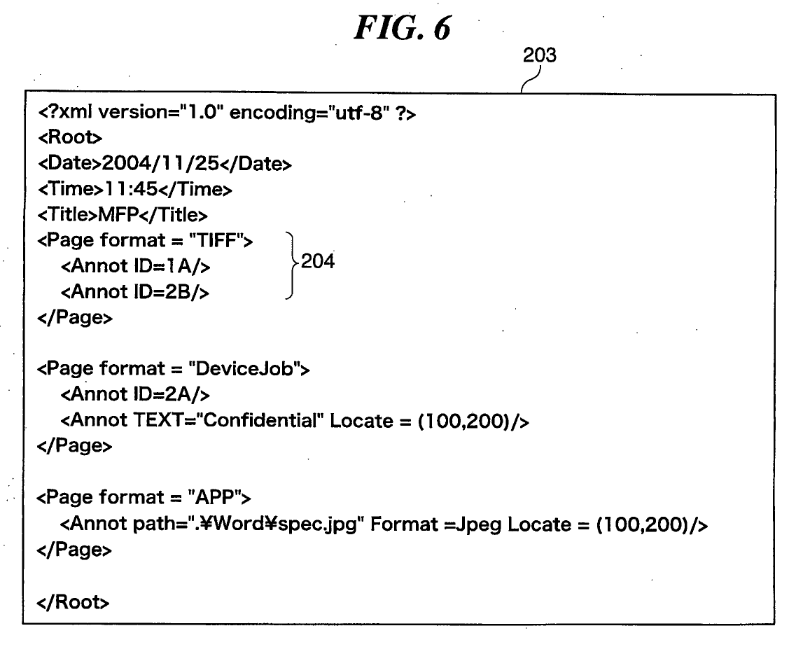

FIG. 6 is a view showing an example of mark control information managed by the document management system 100.

The mark control information 203 is control information on marks and stamps added to data and is written in, for example, XML format as shown in FIG. 6. A statement corresponding to reference numeral 204 indicates that marks with mark IDs “1A” and “2B” are put on the first page of the concerned data, which has a file format “TIFF”.

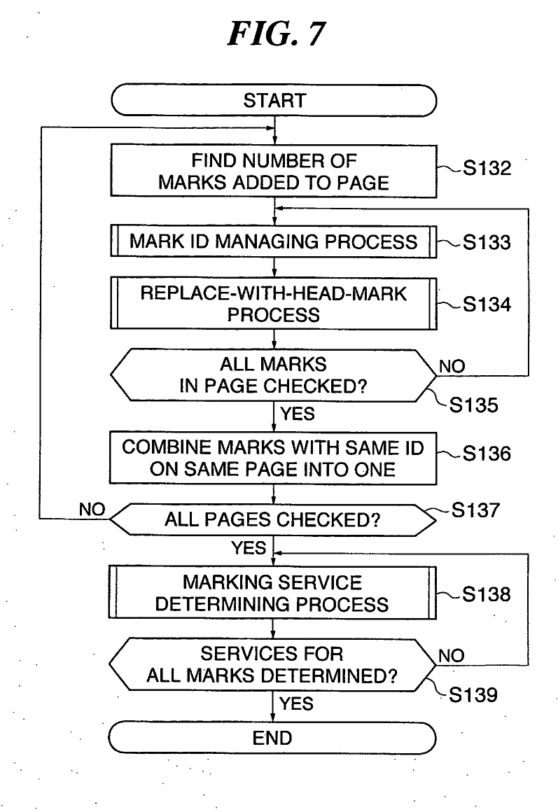

Referring next to FIGS. 7 to 10, a description will be given of a document management method implemented by the printing system in FIG. 1.

FIG. 7 is a flow chart showing a mark managing process carried out by the document management system 100 during printing of a predetermined file.

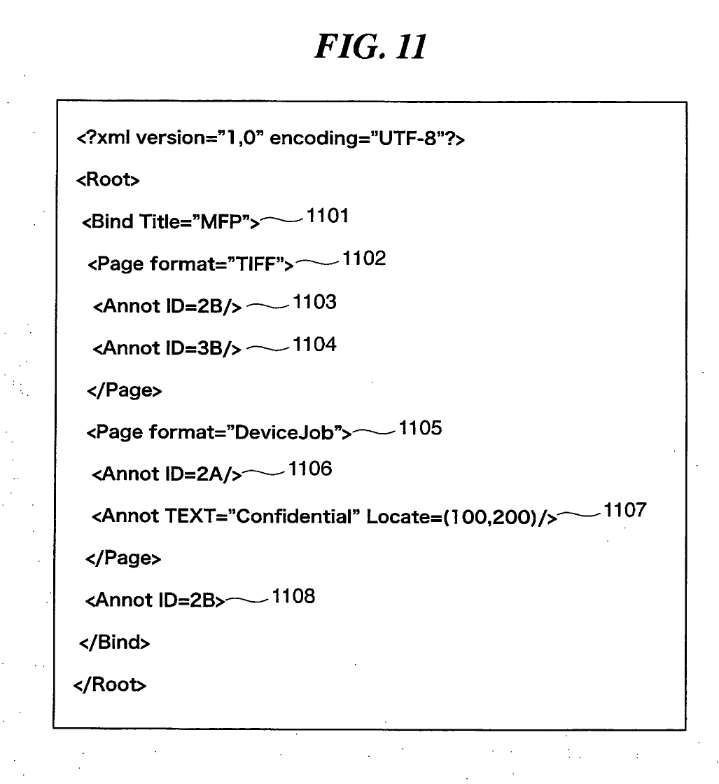

When a printing instruction and data to be printed (for example, application data) are input to the document management system 100, the process in FIG. 7 is started. First, the printing management system 100 analyzes and recognizes mark control information that is input together with the data to be printed. FIG. 11 shows an example of mark control information that is input together with data to be printed.

Referring to FIG. 11, the mark control information is written in XML format as shown in FIG. 6. The application data to be printed, which is input together with the mark control information, is a data file in the form of a binder formed by binding a plurality of files created and output by respective ones of a plurality of applications.

Referring again to FIG. 7, processing in steps S132 to S137 is repeatedly carried out for all the pages of the data to be printed.

In the step S132, first, the mark control information is analyzed to find the number of marks added to the first page of the data to be printed. In the step S132, marks put by the applications 46, marks put using the function of the document management system 100, marks put by devices such as the printer 3000, and so forth are searched for.

In the mark control information according to the present embodiment, “MFP” (reference numeral 1101) is written as the name of the entire data file as shown in FIG. 11. In the mark control information, the page format and the mark ID are designated on a page-by-page basis. For example, the mark control information in FIG. 11 describes that the page format of the first page is “TIFF” (reference numeral 1102), and the page format of the second page is “Device Job” (reference numeral 1105).

The mark ID is comprised of a group ID and a sub ID in the mark information management table 300 in FIG. 3. In the mark control information in FIG. 11, marks with mark IDs “2B” and “3B” (shown at reference numerals 1103 and 1104) are added to the first page. According to the mark information management table 300 in FIG. 3, a mark “Copy not allowed” is put on the first page of the input data diagonally right up from the origin coordinates (0, 0) of the printing area based upon the mark ID “2B” (reference numeral 1103) written in the mark control information. Also, a mark “Reference distribution” is put on the first page of the input data diagonally right up from the origin coordinates (0, 0) of the printing area based upon the mark ID “3B” (reference numeral 1104) written in the mark control information.

On the second page, a mark “Copy inhibit” is put horizontally at the coordinates (10, 20) based upon a mark ID “2A” (reference numeral 1106) written in the mark control information.

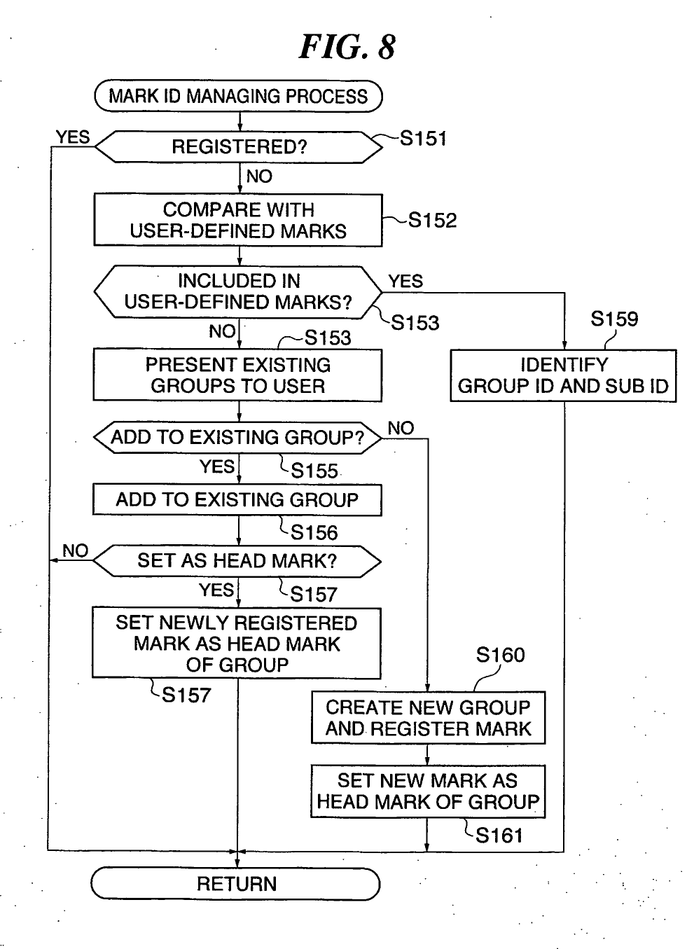

An annotation may be directly written in the mark control information without using a mark ID (reference numeral 1107). In this case, the document management system 100 determines that a step S160 is entered in a mark ID managing process in FIG. 8, described later. Specifically, in the step S160, the document management system 100 registers a mark ID “1D” corresponding to the unregistered mark (reference numeral 1107) in the mark information management table 300. Since the storage location of the mark with the mark ID “1D” is “DM”this information is also registered in the mark information management table 300. In response to this registration, the mark information management table 300 is rewritten, thereby being updated. In the present embodiment, text data “Confidential” is put at the coordinates (100, 200) on the data file. Reference numeral 1108 indicates an instruction for adding the mark with the mark ID “2B” to all the pages of the binder. In this manner, the document management system 100 analyzes and recognizes mark control information.

Next, when the number of marks on the data to be printed is recognized, processing in the steps S133 to. S135 is carried out.

In the step S133, the mark ID managing process, described in detail later, is carried out. The mark ID managing process is a process in which, for example, when one selected from a plurality of marks searched for in the step S132 is new, the new mark is registered in the mark information management table 300.

Next, after the completion of the mark ID managing process in the step S133, a replace-with-head-mark process is carried out as described in detail later (step S134). The replace-with-head-mark process is a process in which the mark selected in the step S133 is replaced with a head mark belonging to the same group in the mark information management table 300. As a result, for example, if two kinds of marks “Confidential” and “Secret” are added to a given page, these marks are replaced with the mark “Confidential” designated as a head mark in advance in the mark information management table 300 by the user.

After the ID managing process in the step S133 and the replace-with-head-mark process in the step S134 have been completed for all the marks in the same page, the process proceeds to the step S136.

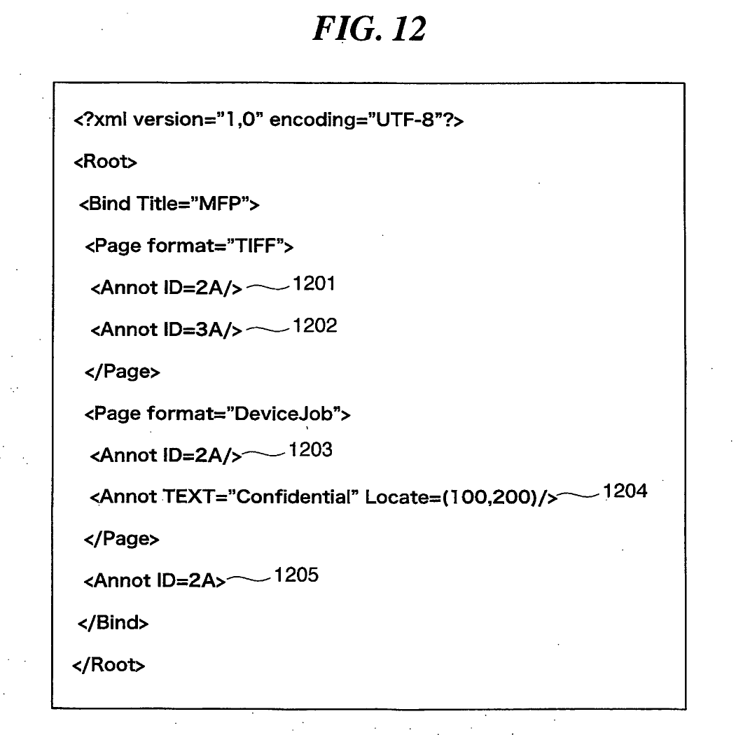

Although description of the replace-with-head-mark process will be described in detail later, the document management system 100 updates the mark control information in FIG. 11 and outputs the updated mark control information in FIG. 12 in the step S134. Specifically, since marks with mark IDs “2A” and “3A” are head marks in the mark information management table 300 and hence if any other marks are added to a given page, they are replaced with the respective corresponding head marks. The processing in the steps S133 to S134 is repeatedly carried out for all the marks in the same page (step S135).

As a result, the marks (reference numerals 1103, 1104, 1106, and 1108) added to the first page among various marks written in the mark control information in FIG. 11 are replaced with the respective corresponding head marks. In the present embodiment, the document management system 100 replaces all the marks with head marks based upon the mark control information in FIG. 11 and the mark information management table 300 in FIG. 3. For example, the mark control information indicated by reference numeral 1103. in FIG. 11 is replaced with the mark control information indicated by reference numeral 1201 in FIG. 12, and the mark control information indicated by reference numeral 1104 in FIG. 11 is replaced with the mark control information indicated by reference numeral 1202 in FIG. 12, respectively. Also, the mark control information indicated by reference numeral 1108 in FIG. 11 is replaced with the mark control information indicated by reference numeral 1205 in FIG. 12.

Next, in the step S136, when there are marks with the same mark ID in the same page, they are combined into one. Specifically, marks replaced with head marks (reference numerals 1201, 1202, and 1205 in FIG. 12) are combined into one.

The mark ID “2A” (reference numeral 1201) is set for the first page. The mark ID “2A” (reference numeral 1205) is also set for all the pages included in the binder. Since the mark IDs are overlapping, the mark ID “2A” (reference numeral 1201) set for the first page is deleted.

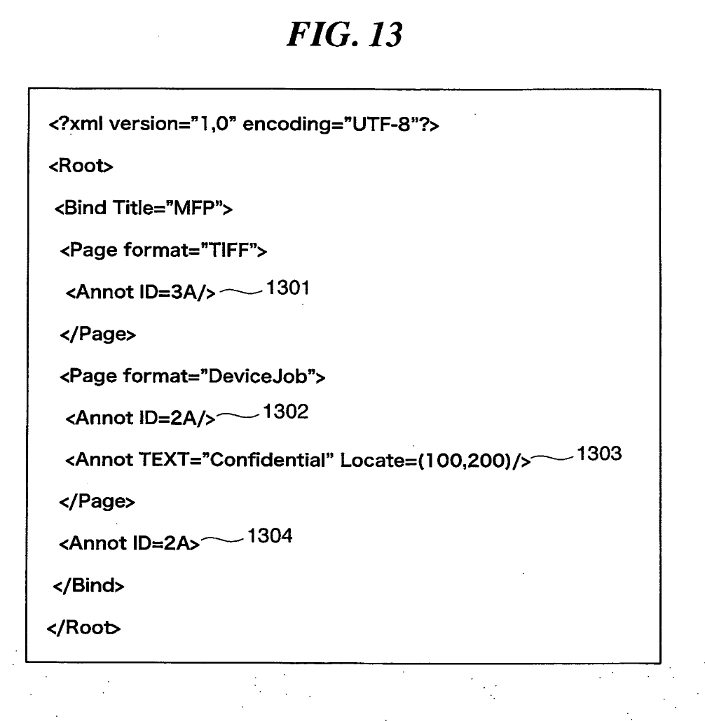

Processing for the second page is carried out as follows: During processing in the step S133, the mark control information indicated by reference numeral 1303 in FIG. 13 is newly registered as a mark with a mark ID “1D” in the mark information management table 300 in a step S156 in FIG. 8, described later, and is set as a head mark of the group having the group ID “1” in a step S158 in FIG. 8. Since the mark ID “2A” (reference numeral 1302) and the mark ID “2A” (reference numeral 1304) are overlapping in the example shown in FIG. 13, they can be combined into one in the step S136.

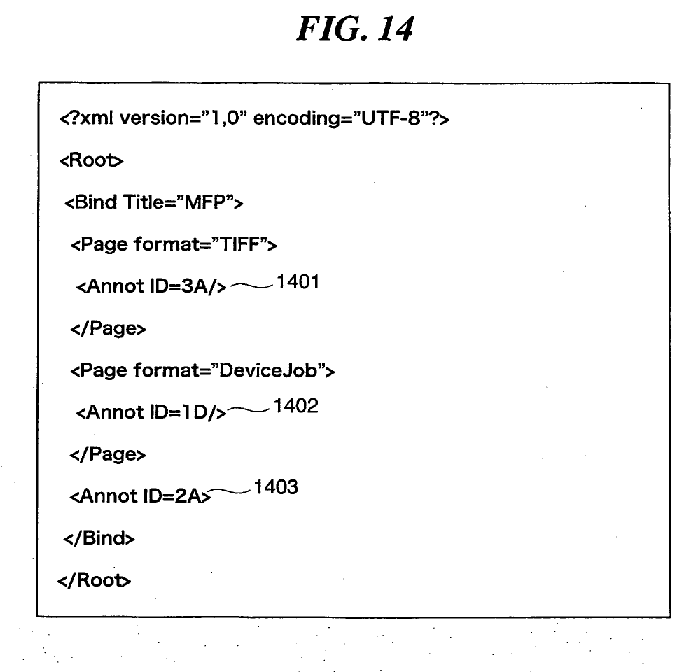

When the execution of the step S137 is completed, mark control information shown in FIG. 14 is output. In the example shown in FIG. 14, the mark ID “2A” is set for all the pages (reference numeral 1403). Also, the mark ID “3A” (reference numeral 1401) is set for the first page, and the mark ID “1D” (reference numeral 1402) is set for the second page.

In the step S136, if there are marks with the same mark ID in the same page, they are combined into one. For example, if the document management system 100 adds the mark “For internal use only” to, a binder formed by binding a file to which the mark “Secret” is added with another file to which the mark “For internal use only” is added using the application 46, the mark “Secret” and the mark “For internal use only” are replaced with the mark “Confidential” in the step S135, but in this case, the two marks “Confidential” are overlapping in the same page. Accordingly, they have to be combined into one.

By repeatedly carrying out the processing in the steps S132 to S137 for all the pages of the data file, the marks on all the pages are replaced with the head marks designated in advance by the user, and therefore the situation where a plurality of kinds of marks having a common meaning exist on the same page can be avoided.

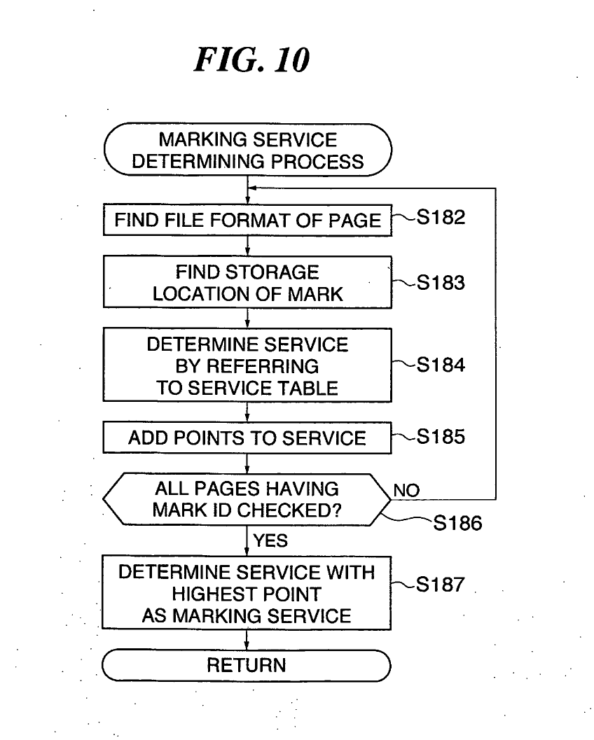

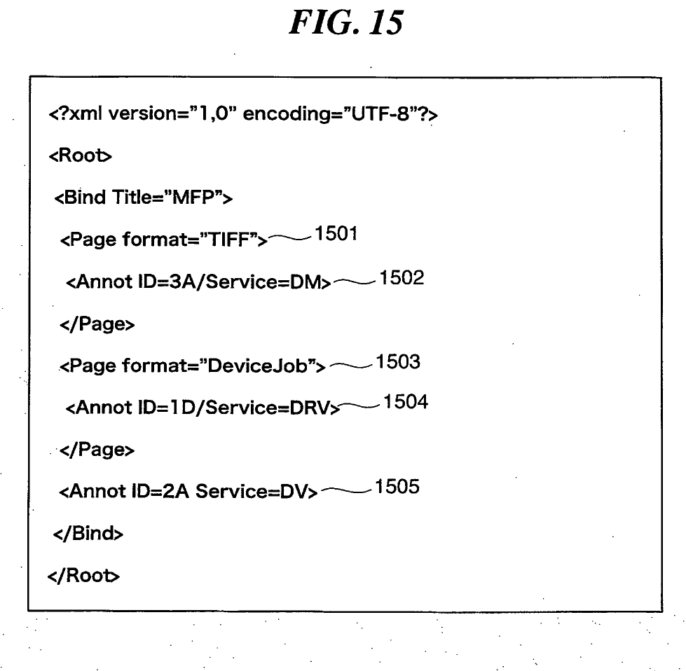

Next, in a step S138, a marking service determining process, described in detail later, is carried out with respect to each of the head marks which have been determined to be put. First, the document management system 100 searches the file format of the first page by focusing attention on the mark ID “3A” based on the marking service table 400 (step S182 in FIG. 10). For example, assume that the format of the first page is identified as “TIFF” (reference numeral 1501) as shown in FIG. 15. On this occasion, the document management system 100 determines that it is desirable for the document management system 100 to add data (the mark ID “3A” indicated by reference numeral 1502) stored in the document management system 100 (see the mark storage locations 116 in FIG. 3) to the TIFF data. The storage location of the mark with the mark ID “3A” is managed in the mark information management table 300 in FIG. 3. If the mark ID “3A” is set for other pages as well, the document management system 100 searches and determines the most suitable marking services for putting the mark with the mark ID “3A” as described later.

In the present embodiment, it is determined that the document management system 100 is the most suitable marking service for the mark with the mark ID “3A” on the first page. In FIG. 15, “Service=DM” (reference numeral 1502) is set, which indicates that the document management system 100 is set as the marking service.

Next, the document management system 100 searches the format of the second page by focusing attention on the mark ID “1D.” As shown in FIG. 15, the format of the second page is identified as “Device Job” (reference numeral 1503). The mark with the mark ID “1D” is a user-defined mark in the document management system 100. Thus, it is determined that the printer driver “DRV” is the most suitable marking service. The document management system 100 then reflects the determination result on the mark control information (reference numeral 1504).

In the mark control information, a statement corresponding to reference numeral 1505 indicates that the mark with the mark ID “2A” is set for the binder of application files (that is, all the pages). The mark with the mark ID “2A” is stored inside the device (DV) (see the mark storage locations 116 in FIG. 3). Thus, it is determined that the device is the most suitable marking service. In this manner, the determination of the marking service is repeatedly carried out for all the pages. The document management system 100 then reflects the determination results on the mark control information (reference numeral 1505).

It is then determined whether or not the most suitable services have been determined for all the head marks (step S139). If the determination result is negative, the process returns to the step S138, and if the determination result is positive, the present process is terminated. After terminating the present process, the document management system 100 outputs mark control information shown in FIG. 15, described in detail later.

FIG. 8 is a flow chart showing in detail the mark ID managing process in the step S133 in FIG. 7.

As shown in FIG. 8, first, it is determined whether or not one that is selected from among a plurality of kinds of marks searched for in the step S132 in FIG. 7 has already been registered in the mark information management table 300 (step S151). If the selected mark has already been registered in the mark information management table 300, the process returns.

On the other hand, if the selected mark has not yet been registered in the mark information management table 300, it is compared with user-defined marks registered in advance in the mark information management table 300 (step S152). It is then determined whether or not the selected mark corresponds to any of the user-defined marks (step S153). If the selected mark corresponds to any of the user-defined marks, the group ID and sub ID of the corresponding user-defined mark are identified (step S159), and the process returns.

On the other hand, if the selected mark has not yet been registered in the mark information management table 300 and does not correspond to any of the user-defined marks (NO to the step S153), it can be determined that the selected mark is a new mark that has not been managed up to the present, and hence the concerned mark has to be additionally registered in the mark information management table 300. To cause the user to ascertain whether or not the new mark belongs to any of the existing groups, the existing groups are presented to the user via the CRT 10 (step S154).

Next, the user is caused to determine whether to additionally register the new mark in any of the existing groups (step S155). If the user determines not to additionally register the new mark in any of the existing groups (NO to the step S155), a new group is created, and the new mark is registered in the created new group (step S160). Since only one kind of mark is registered in the new group, the present mark is set as a head mark (step S161), and the process returns.

On the other hand, if the user determines to additionally register the new mark in any of the existing groups (YES to the step S155), the new mark is additionally registered in the existing group designated by the user (step S156). The user is then caused to determine whether to set the newly registered mark as a head mark of the group to which the newly registered mark belongs (step S157). If the user determines to set the newly registered mark as the head mark (YES to the step S157), the mark that is currently set as the head mark is canceled, and the newly registered mark is set as the head mark (step S158). The process then returns. All the marks registered additionally in the above process are reflected on the mark information management table 300.

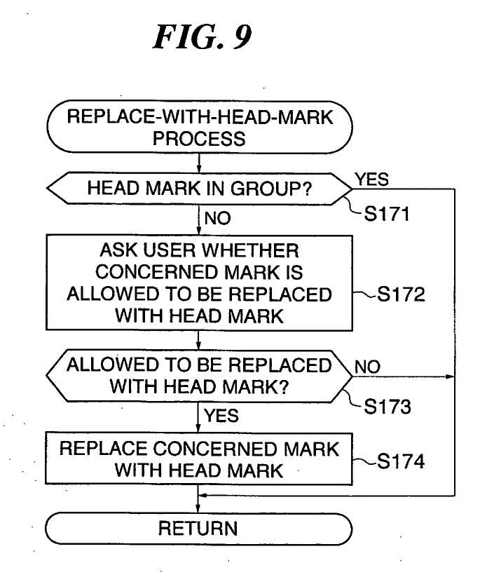

FIG. 9 is a flow chart showing in detail the replace-with-head-mark process in the step S134 in FIG. 7.

As shown in FIG. 9, it is determined whether or not one selected from among a plurality of kinds of marks searched for in the step S132 in FIG. 7 is a head mark of the corresponding group in the mark information management table 300 (step S171). If it is determined that the selected mark is the head mark, the process returns since replacement of the selected mark is unnecessary.

On the other hand, if it is determined that the selected mark is not the head mark (NO to the step S171), a predetermined screen, not shown, is displayed on the CRT 10 to prompt the user to determine whether to allow the selected mark to be replaced with the head mark (step S172). It is then determined whether or not the user has allowed the selected mark to be replaced with the head mark (step S173). If it is determined that the user has allowed the selected mark to be replaced with the head mark, the selected mark is replaced with the head mark of the corresponding group (step S174), and the process returns. On the other hand, if it is determined that the user has not allowed the selected mark to be replaced with the head mark (NO to the step S173), the process returns without replacement of the selected mark.

In the above process, the user is caused to determine whether to carry out replacement with respect to all the marks in the step S172, but all the marks may automatically be replaced with head marks. For example, each mark is provided with information such as “to be automatically replaced”, “not to be automatically replaced”, or “ask the user each time”, or each group is provided with similar information. If such information is managed by the user, control can be achieved such that marks allowed to be automatically replaced are automatically replaced with head marks, marks not allowed to be automatically replaced with head marks are not automatically replaced and the user is asked about marks which the user is desired to be asked about each time.

FIG. 10 is a flow chart showing in detail the marking service determining process in the step S138 in FIG. 7. This process is carried out for all the marks to be put by printing designated by the user. Here, the loop from a step S182 to a step S185 is carried out for all the pages to which marks are to be put.

As shown in FIG. 10, the document management system 100 searches the file format of the concerned page (step S182). The file format means the “file format” registered in the marking service table 400. Here, it is checked whether the concerned page belongs to a file created using an application, a general-purpose image file such as TIFF or BMP, or a file (e.g., a device job document) managed by, for example, the BOX 55 of the printer 3000.

Next, the storage location of a mark to be put on the concerned page is searched (step S183). Here, it is checked whether data of the mark to be put on the concerned page is included in the actual file (the inside of the file (F) as the mark storage location 121), is managed by the document management system 100 (the inside of the document management system (DM) as the mark storage location 121), or is managed by, for example, the BOX 55 of the printer 3000 (the inside of the device DV as the mark storage location 121). The determination may be carried out referring to the mark storage locations 116 in the mark information management table 300 in FIG. 3.

Next, which service, i.e., which program is suitable for efficient marking is determined based on the information collected in the steps S182 and S183 and the marking service table 400 (step S184).

Next, points are added to the service determined in the step S184 (step S185). Finally, points are added with respect to all the pages, and it is determined that the service with the highest point is to be used for marking in printing (step S187). The process then returns.

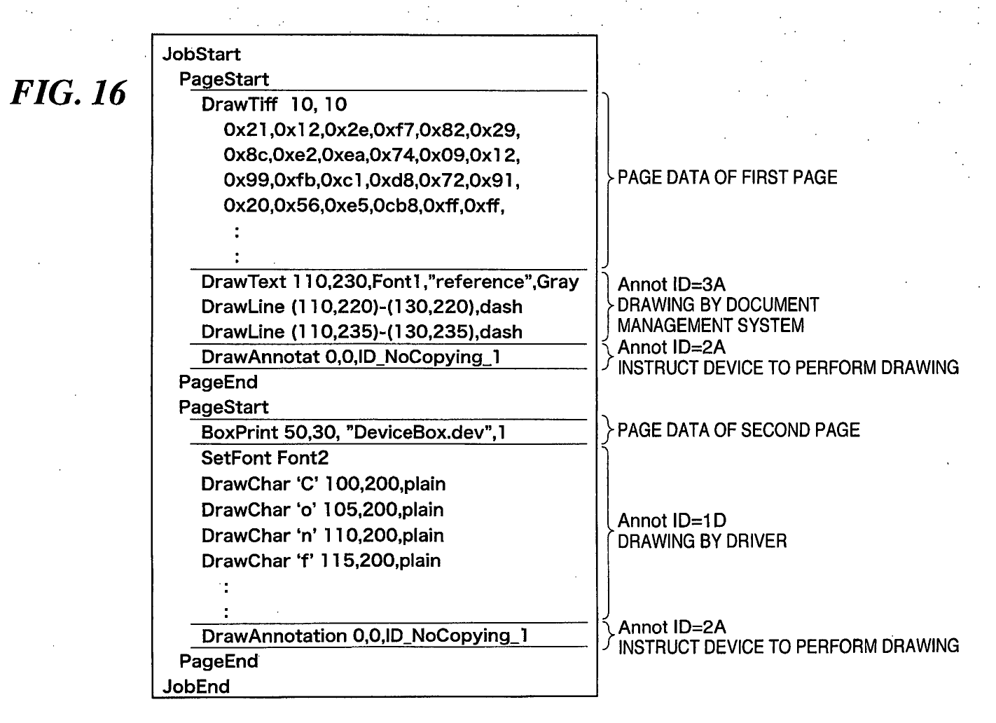

After the completion of the process in FIG. 7, the mark control information in FIG. 15 is generated by the document management system 100. Processing is performed on the mark control information and the input application data (data to be printed which has been created by an application). Print job data in FIG. 16 is generated based on the application data which is managed by the document management system 100 and is to be printed. The print job data is described in Page Description Language (PDL) comprised of a printing command group, and is sent to the printer 3000. The printer 3000 analyzes the received print job data and carries out drawing processing with respect to each page.

In FIG. 16, the first-page data is TIFF data, in which two marks are designated. One is the mark with the mark ID “3A” to be put by the document management system 100. This mark is put by the document management system 100 in accordance with the information indicated by reference numeral 1502. In the print job data to be sent to the printer 3000, the mark is replaced with a plurality of PDL drawing commands (here, DrawText commands and DrawLine commands) in accordance with the information indicated by reference numeral 1502.

The other one is the mark with the mark “2A” to be put by the device. Here, a DrawAnnotation command for instructing the printer to draw the mark is used to instruct the printer to perform drawing via the printer driver 200. The image processing execution section 51 combines images in the same manner as in form overlay processing.

The second-page data is a device job document which is stored in the BOX information managing section 54 of the device, and in which two marks are designated. One is the mark with the mark ID “1D” for which the marking service is to be provided by the printer driver 200. In the print job data to be sent to the printer 3000, the just-mentioned mark is replaced with a plurality of PDL drawing commands (here, SetFont. commands and DrawChar commands) for the printer driver 200 in accordance with the information indicated by reference numeral 1505.

The other one is the mark with the mark ID “2A” for which the marking service is to be provided by the device. Here, a DrawAnnotation command is used to instruct the printer to perform drawing.

The above print job data is processed by the printer driver 200. Based on the processed data the image processing execution section 51 then forms images. Further, the image processing execution section 51 combines the mark data stored in the BOX information managing section 54 and the data of the formed images into bit-mapped data. Finally, the printer controller 4000 causes the printing mechanism unit 28 to print the data on recording sheets on a page-by-page basis.

According to the above described embodiment, a plurality of kinds of marks added to data files are replaced with a head mark having a common meaning based upon the mark information management table 300 defined in advance by the user. It is therefore possible to replace a plurality of kinds of marks added to a document file or an image file with a head mark having a same meaning without editing respective ones of the marks, whereby a print output giving a feeling of consistency can be obtained in an efficient manner.

Also, in printing a head mark on a data file, the most suitable program, device, or the like for putting the head mark is determined according to the file format and the storage location of the head mark registered in the marking service table 400, and therefore the optimum mark images and performance can be obtained.

Although in the above described embodiment, the storage locations of marks are manually registered in the marking service table 400 by the user, this is not limitative, but the document management system 100 may automatically search the printing system for marks and register them in the marking service table 400.

Similarly, the document management system 100 may automatically search for and register the most suitable program, driver, and device for putting marks used on the printing system.

The document management system 100 may be implemented by either software or hardware insofar as the above described functions can be realized.

It is to be understood that the object of the present invention may also be accomplished by supplying a system or an apparatus with a storage medium in which a program code of software, which realizes the functions of the above described embodiment is stored, and causing a computer (or CPU or MPU) of the system or apparatus to read out and execute the program code stored in the storage medium.

In this case, the program code itself read from the storage medium realizes the functions of the above described embodiment, and hence the program code and a storage medium on which the program code is stored constitute the present invention.

Examples of the storage medium for supplying the program code include a floppy (registered trademark) disk, a hard disk, a magnetic-optical disk, an optical disk such as a CD-ROM, a CD-R, a CD-RW, a DVD-ROM, a DVD-R, a DVD+R, a DVD-RAM, a DVD-RW, a DVD+RW, a magnetic tape, a nonvolatile memory card, and a ROM. Alternatively, the program code may be downloaded via a network.

Further, it is to be understood that the functions of the above described embodiment may be accomplished not only by executing a program code read out by a computer, but also by causing an OS (operating system) or the like which operates on the computer to perform a part or all of the actual operations based on instructions of the program code.

Further, it is to be understood that the functions of the above described embodiment may be accomplished by writing a program code read out from the storage medium into a memory provided in an expansion board inserted into a computer or a memory provided in an expansion unit connected to the computer and then causing a CPU or the like provided in the expansion board or the expansion unit to perform a part or all of the actual operations based on instructions of the program code.

While the present invention has been described with reference to exemplary embodiment, it is to be understood that the invention is not limited to the disclosed exemplary embodiment. The scope of the following claims is to be accorded the broadest interpretation so as to encompass all modifications, equivalent structures and functions.

This application claims the benefit of Japanese Applications Nos. 2005-047506 filed Feb. 23, 2005 and 2006-007975 filed Jan. 16, 2006 which are hereby incorporated by reference herein in their entirety.

What is claimed is:

1. A document management apparatus that adds at least one mark to data and causes a printing apparatus to print the data, comprising:
a mark information storing device that stores a mark information management table which includes a plurality of kinds of marks that are classified into groups, and head marks as each of which one of marks belonging to a corresponding one of the groups is set; and
a mark replacing device that replaces at least one mark added to the data with at least one of the head marks by referring to the mark information management table when an instruction for printing the data is given to the printing apparatus.

2. A document management apparatus according to claim 1, further comprising:
a service table storing device that stores a marking service table in which data formats, storage locations of marks that can be added to data having the data formats, and suitable programs for adding these marks are set; and
a determining device that determines a suitable program for adding the at least one of the head marks by referring to the marking service table when the instruction for printing the data is given to the printing apparatus.

3. A document management apparatus according to claim 1, further comprising a mark information management table editing device that edits the mark information management table.

4. A document management apparatus according to claim 3, wherein said mark information management table editing device registers at least one mark unregistered in the mark information management table among the at least one mark added to the data as at least one new mark.

5. A document management apparatus according to claim 3, wherein said mark information management table editing device registers at least one mark defined by a user in the mark information management table.

6. A document management apparatus according to claim 1, wherein, when a printer driver is set as the program for adding the mark, the printer driver processes data using an API so as to output the mark, and when an application is set as the program for adding the mark, the application processes data using the API so as to output the mark.

7. A document management method for a document management apparatus that adds at least one mark to data and causes a printing apparatus to print the data, comprising:
a mark information storing step of storing a mark information management table which includes a plurality of kinds of marks that are classified into groups, and head marks as each of which one of marks belonging to a corresponding one of the groups is set; and
a mark replacing step of replacing at least one mark added to the data with at least one of the head marks by referring to the mark information management table when an instruction for printing the data is given to the printing apparatus.

8. A document management method according to claim 7, further comprising:
a service table storing step of storing a marking service table in which data formats, storage locations of marks that can be added to data having the data formats, and suitable programs for adding these marks are set; and
a determining step of determining a suitable program for adding the at least one of the head marks by referring to the marking service table when the instruction for printing the data is given to the printing apparatus.

9. A document management method according to claim 7, further comprising a mark information management table editing step of editing the mark information management table.

10. A document management method according to claim 9, wherein in said mark information management table editing step, at least one mark unregistered in the mark information management table among the at least one mark added to the data is registered as at least one new mark.

11. A document management method according to claim 9, wherein in said mark information management table editing step, at least one mark defined by a user is registered in the mark information management table.

12. A document management method according to claim 7, wherein, when a printer driver is set as the program for adding the mark, the printer driver processes data using an API so as to output the mark, and when an application is set as the program for adding the mark, the application processes data using the API so as to output the mark.

13. A computer-readable program for causing a computer to implement a document management method for a document management apparatus that adds at least one mark to data and causes a printing apparatus to print the data, comprising:
a mark information storing module for storing a mark information management table which includes a plurality of kinds of marks that are classified into groups, and head marks as each of which one of marks belonging to a corresponding one of the groups is set; and
a mark replacing module for replacing at least one mark added to the data with at least one of the head marks by referring to the mark information management table when an instruction for printing the data is given to the printing apparatus.

14. A document management system that sends data with at least one predetermined mark added thereto from an information processing apparatus to a printing apparatus, the information processing apparatus comprising:
a mark information storing device that stores a mark information management table which includes a plurality of kinds of marks that are classified into groups, and head marks as each of which one of marks belonging to a corresponding one of the groups is set;
a service table storing device that stores a marking service table in which data formats, storage locations of marks that can be added to data having the data formats, and suitable programs for adding these marks are set;
a mark replacing device that replaces at least one mark added to the data with at least one of the head marks by referring to the mark information management table when an instruction for printing the data is given to the printing apparatus; and
a determining device that determines a suitable program for adding the at least one of the head marks by referring to the marking service table when the instruction for printing the data is given to the printing apparatus.

15. An information processing apparatus comprising:
an execution device that executes a plurality of services for outputting data;
a determining device that determines a service for adding marks from among the plurality of services; and
an output control device that controls output processing of the service determined by said determining device such that the data with the marks added thereto is output.

16. An information processing apparatus according to claim 15, wherein the service includes at least one of an application program that outputs application data, a printer driver that outputs print data based upon the application data, and an image forming service of a printing apparatus that outputs bit-mapped data from the print data.

17. An information processing apparatus according to claim 15, wherein said determining device specifies kinds of the marks and determines services for adding the marks in accordance with the specified kinds.

18. An information processing apparatus according to claim 17, wherein in a case where the plurality of services are set to add the marks of which kinds have been specified to data, said determining device determines a service for adding the marks from among the plurality of services that are set to add the marks to data.

19. An information processing method comprising:
an execution step of executing a plurality of services for outputting data;
a determining step of determining a service for adding marks from among the plurality of services; and
an output control step of controlling output processing of the service determined in said determining step such that the data with the marks added thereto is output.

20. An information processing method according to claim 19, wherein the service includes at least one of an application program that outputs application data, a printer driver that outputs print data based upon the application data, and an image forming service of a printing apparatus that outputs bit-mapped data from the print data.

21. An information processing method according to claim 19, wherein in said determining device, kinds of the marks are specified, and services for adding the marks are determined in accordance with the specified kinds.

22. An information processing method according to claim 21, wherein in said determining step, in a case where the plurality of services are set to add the marks of which kinds have been specified to data, a service for adding the marks is determined from among the plurality of services that are set to add the marks to data.

23. A program readable by a computer, comprising:
an execution module for executing a plurality of services for outputting data;
a determining module for determining a service for adding marks from among the plurality of services; and
an output control module for controlling output processing of the service determined by said determining module such that the data with the marks added thereto is output.
